(19) United States
(12) Patent Application Publication
(10) Pub. No.: US 2004/0042010 A1
(43) Pub. Date: Mar. 4, 2004

(54) Light barrier and light barrier grid

(75) Inventor: Martin Wuestefeld, Sexau (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 10/652,960

(22) Filed: Aug. 28, 2003

(30) Foreign Application Priority Data
Aug. 30, 2002 (DE) 102 39 940.9

(51) Int. Cl. G01B 11/00

(52) U.S. Cl. 356/400

(57) ABSTRACT

A light barrier or light barrier grid has two housings in which a light source and a light receiver are arranged. In addition, an apparatus for aligning the two housings is provided. For this purpose, the first housing includes an alignment light emitter, while a mirror is arranged in the second housing. An alignment beam generated by the alignment light emitter is reflected by the mirror onto itself, or nearly onto itself.

### BACKGROUND OF THE INVENTION

The present invention relates to a light barrier or light barrier grid in which a light source is arranged in a first housing and a corresponding light receiver in a spaced-apart, second housing.

Light barriers or light barrier grids (hereafter “light grids”) are used to monitor desired areas or spaces. A light barrier uses a single light beam, while light grids use a plurality of parallel light beams.

The word “light” is not limited to visible light. For purposes of this application, “light” generally includes electromagnetic radiation, such as ultraviolet (UV) light, infrared (IR) light, as well as visible light, which generally can be used for operating light barriers and light grids.

A problem encountered with known light barriers and grids relates to the alignment of the associated housings which hold the light source as well as the light receiver. Such housings can be moved in multiple ways and directions; for example they can be tilted, rotated or moved linearly. As a result, it is known to use arrangements for the alignment of the two housings.

EP 0 889 332 B1 discloses an arrangement for the alignment of such housings. The publication discloses several embodiments for such arrangements. The embodiments shown in FIGS. 2 and 3 of the publication use two alignment beams at the respective upper and lower ends of the housings. One of the housings has an alignment light emitter, and the other housing a corresponding alignment light receiver. A disadvantage of this arrangement is that it uses two alignment beams each requiring an emitter and a receiver, which is costly. In addition, making adjustments is time consuming. In the embodiment shown in FIG. 4 of the publication, the alignment apparatus uses an alignment light emitter at the top of one of the housings and an alignment light receiver at the lower end of the other housing. The other housing has a deflection mirror pair. The first deflecting mirror reflects the light from the alignment light emitter onto the second deflecting mirror, which in turn reflects the light beam back onto the alignment light receiver at the first housing. According to the publication, a disadvantage of this embodiment is that the deflecting mirrors must be precisely aligned because angular misalignments quadruple in the system.

### SUMMARY OF THE INVENTION

It is therefore an object of the present invention to provide a light barrier or light grid of the type described above, which is relatively inexpensive and which has a reliable alignment apparatus for aligning the two housings.

Broadly speaking, this is attained by reflecting the alignment beam from the first housing with a mirror at the second housing so that the alignment beam is reflected onto itself, or nearly so.

This provides an alignment apparatus for light barriers, and particularly for light grids, which is relatively inexpensive and which greatly simplifies the alignment of the two housings. The idea underlying the invention is to reflect the alignment beam back onto itself, that is, in alignment with the beam from the emitter beam or, when an alignment light receiver is used, to reflect the beam as closely as possible parallel to the beam from the emitter. It is possible to use a plurality of alignment beams. The alignment beam(s) is/are parallel to the light beam(s) of the light barrier or light grid. An alignment is made as follows:

The housing with the alignment light emitter is tilted, and moved rotationally or linearly until the alignment beam strikes the mirror at the other housing. Thus, the mirror constitutes the initial aim for the alignment beam. Thereafter the housing with the light beam is tilted, and moved rotationally and/or linearly until the alignment beam is reflected back onto itself and strikes the alignment light emitter. This is the final aim. A laser or point light source is used as the light source. The alignment beam is almost collimated. The light of the alignment light emitter is visual light so that alignment can be achieved without other aids, such as a receiver, for example, solely on the basis of an optical recognition. It is preferred that the alignment light emitter become automatically deactivated after a predetermined time interval. In addition, the light from the alignment light emitter can be modulated or it can be operated with constant light.

In another embodiment of the invention, the alignment light beam is polarized. A tilting of the housing with the mirror can be detected by rotationally moving the housing about an axis parallel to the axis of the alignment light beam. In such a case, the intensity of the reflected alignment beam is greatest when the rotational angle is zero.

In another embodiment of the invention, the mirror is a flat mirror and its surface is perpendicular to the optical axis of the alignment beam.

In a further alternative, a nonplanar mirror, preferably a cylindrically shaped mirror, is used. When the housing with the mirror is rotationally moved as described above, reflected light received at the housing with the alignment light emitter becomes deformed as compared to the reflected light received when the housing has not been rotationally moved. By giving the light beam a line shape, the reflected light has a minimal height when the rotational angle is zero.

In another approach, the present invention places a slitted aperture in front of the mirror, and the alignment beam is linearly shaped. An inclination of the reflected alignment beam indicates rotational movement.

A further embodiment of the present invention places a material, such as a foil, about the mirror and the alignment light emitter as an aid for seeing when the alignment beam does not precisely strike the mirror and/or alignment light emitter (after its reflection). This material makes it easier to recognize the alignment beam when it is received outside the targeted area. The advantage provided by this embodiment is that it provides enhanced visibility which facilitates the alignment of the system. It provides both a larger area where the misaligned alignment beam can be recognized, and better visibility of the beam where it impacts the foil. A particularly suitable material is reflecting foil, but other materials, such as paint, which can be applied onto a substrate, can also be used.

In another embodiment of the present invention, the mirror is only partially reflecting and permits passage of a portion of the received alignment beam onto a light receiver that is coupled to a signal processor for generating visual and/or acoustic signals. Such an arrangement is particularly advantageous when the housings are spaced far apart. The visual and/or acoustic signal generator indicates when the desired alignment has been attained.

In the above-summarized embodiments of the invention, the alignment beam is reflected exactly onto itself. In a further embodiment of the invention, the reflected alignment beam diverges slightly so that it is nearly but not exactly reflected onto itself. Such an arrangement is used when an alignment light receiver is placed adjacent the alignment light emitter because the two are necessarily slightly offset relative to each other, in which event the use of a common optical axis is not possible. By using an alignment light receiver, a signal processor can be coupled thereto, which generates a visual and/or acoustic signal. The signal processor preferably generates a signal the magnitude of which increases as the alignment beam approaches the exact desired position.

It is also possible to place the light emitter(s) in one housing and the corresponding light receivers in the other housing.

Alternatively, the emitters and receivers can be arranged in the same housing, in which event the other housing has the needed deflecting mirrors to return the beam.

Six embodiments of the present invention for a light barrier or light grid are shown in the drawings and described below.

### BRIEF DESCRIPTION OF THE DRAWINGS

FIG. 1 shows as a first embodiment a basic version of an alignment apparatus constructed in accordance with the invention;

FIG. 2 shows a second embodiment which uses polarized light and a polarizing filter;

FIG. 3 shows a third embodiment of the invention which uses cylindrical mirrors;

FIG. 4 shows a fourth embodiment of the invention which uses a slitted aperture;

FIG. 5 shows a fifth embodiment of the invention which uses a reflecting foil; and

FIG. 6 shows a sixth embodiment of the invention which makes use of visual or acoustic signals.

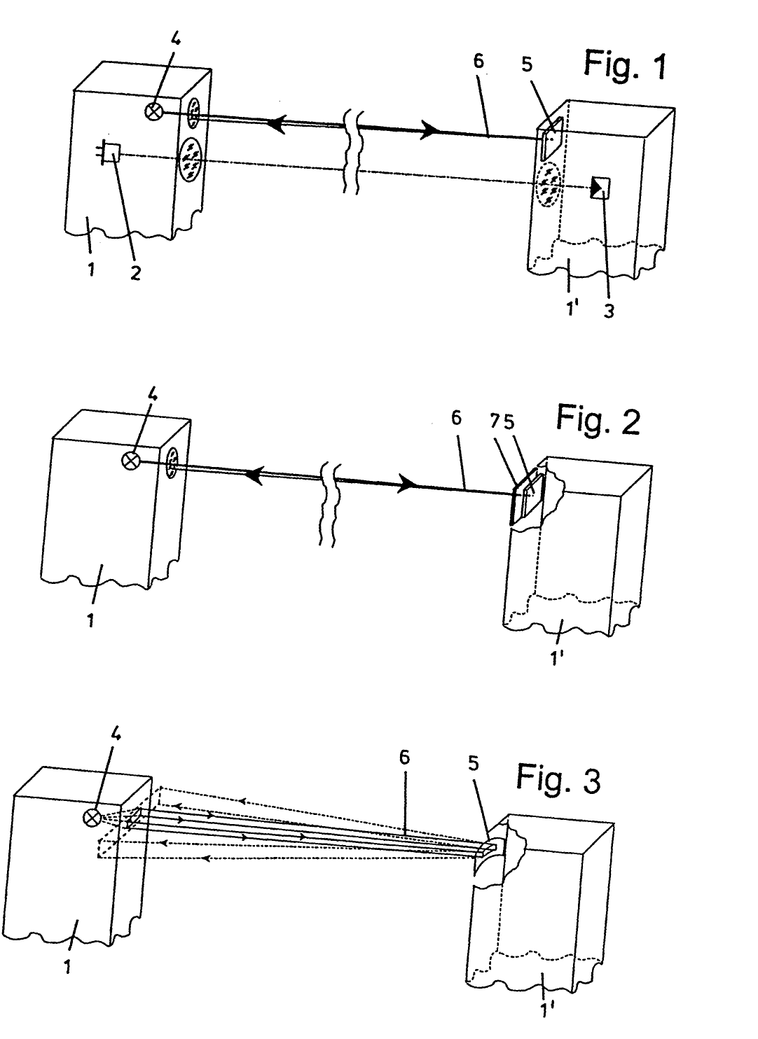

### DESCRIPTION OF THE PREFERRED EMBODIMENTS

The first embodiment of the alignment apparatus of the present invention constitutes a basic version that has two housings 1, 1′. Housing 1 has a light source 2 and the other Housing 1′ a light receiver 3 of a light barrier.

In addition, the embodiment includes an alignment apparatus which has an alignment light emitter 4 in housing 1 and a mirror 5 in housing 1′. The mirror surface is arranged perpendicular to an optical axis of the light barrier.

The alignment apparatus functions as follows:

Alignment light emitter 4 emits an alignment beam 6. When properly adjusted, alignment beam 6 strikes mirror 5, which reflects it back onto itself so that it strikes alignment light emitter 4 again. By tilting or moving housing 1′, the directionality of alignment beam 6 can be adjusted so that its reflection precisely coincides with the desired impact point for the reflected beam.

A second embodiment is shown in FIG. 2 and uses polarized light. A polarizing filter 7 is positioned in front of mirror 5. By rotationally moving Housing 1 about the axis of alignment beam 6, the intensity of the reflected alignment beam 6 is weakened, which is a measurement of the tilt angle.

A third embodiment is shown in FIG. 3, and it uses a cylindrical mirror 5. When housing 1′ is rotationally moved about the axis of alignment beam 6, a deformed reflected light beam strikes housing 1. If there is no rotational movement, the reflected light has a minimal height when the alignment beam 6 comprises a line-shaped light beam.

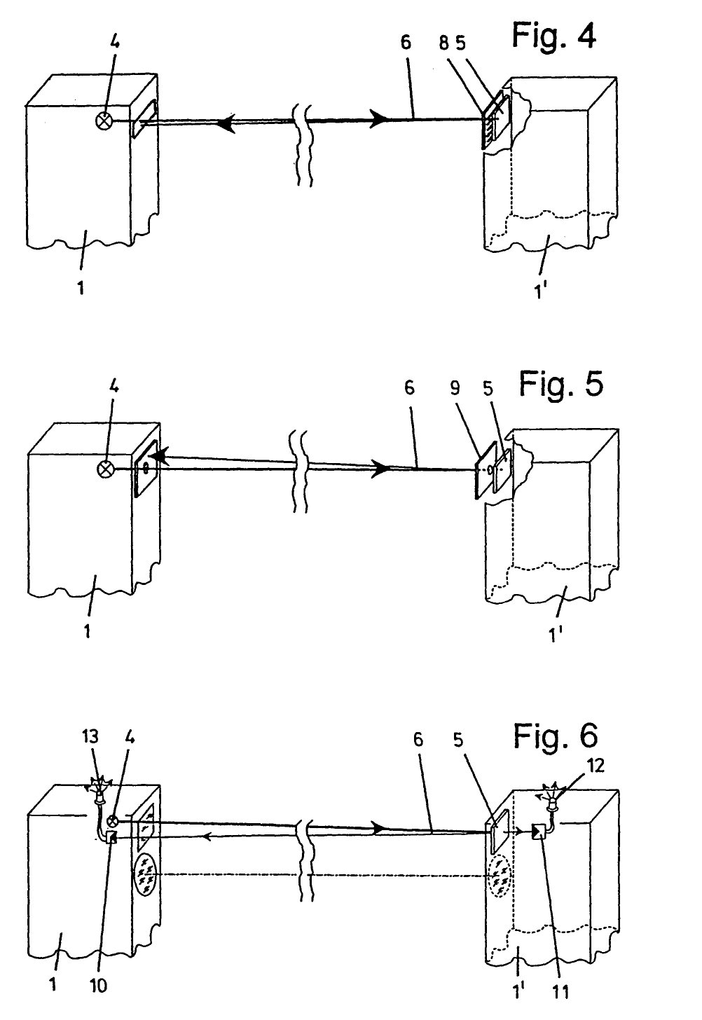

The fourth embodiment shown in FIG. 4 uses a slit-shaped alignment beam 6 and places a slitted aperture 8 in front of mirror 5. As a result of the slits, a tilt deviation of housing 1′ can be detected.

In the fifth embodiment of the invention shown in FIG. 5, a special material, for example a reflecting foil, is placed about alignment beam 6 at the respective housings 1, 1′. An advantage of this embodiment is that the material 9 surrounds the desired position of the alignment beam 6 with a large surface. This makes it easier to see when alignment beam 6 is not at the desired position, which makes adjustments easier to perform.

A sixth embodiment of the invention is shown in FIG. 6. In addition to the alignment light emitter, housing 1 includes an alignment light receiver 10. Further, mirror 5 is only partially reflecting and permits passage of some light. In this case, another alignment light receiver 11 is arranged behind (downstream of) mirror 5 and is coupled to a signal processor 12. This embodiment is particularly advantageous for large distances. When alignment beam 6 strikes alignment light receiver 11 in housing 1′, signal processor 12 generates a correspondingly strong signal. The same applies to the reflected alignment beam 6. When it strikes alignment light receiver 10 in housing 1, a further signal processor 13 generates a correspondingly strong signal.

What is claimed is:

1. A light barrier or light grid comprising first and second, spaced-apart housings, a light source and a light detector, and an alignment apparatus for aligning the housings, the alignment apparatus including an alignment light emitter at the first housing which emits an alignment beam and a mirror on the second housing positioned to reflect the alignment beam back to the first housing, the mirror being arranged so that the reflected alignment beam is in substantial alignment with the alignment beam from the first housing.

2. A light barrier or grid in accordance with claim 1 wherein the alignment light emitter is a polarized light emitter, and including a polarizing filter placed in front of the mirror.

3. A light barrier or grid according to claim 1 wherein the mirror is a flat mirror.

4. A light barrier or grid according to claim 1 wherein the mirror is nonplanar.

5. A light barrier or grid according to claim 4 wherein the mirror comprises a cylindrically shaped mirror.

6. A light barrier or grid according to claim 1 wherein the alignment beam is a line beam, and including a slitted aperture positioned in front of the mirror.

7. A light barrier or grid according to claim 1 including a material at at least one of the alignment light emitter and the mirror arranged to surround the alignment beam and constructed of a material which enhances a visibility of the alignment beam striking the material.

8. A light barrier or grid according to claim 1 wherein the mirror is a partially reflecting mirror which permits passage of a portion of the alignment beam, and including an alignment light receiver arranged downstream of the mirror, and a signal processor coupled with the alignment light receiver for generating at least one of a visually and acoustically enhanced signal.

9. A light barrier or grid according to claim 1 including an alignment light receiver arranged adjacent to the alignment light emitter, and a signal processor operatively coupled to the alignment light receiver for generating an enhanced visual or acoustic signal.

10. A light barrier or grid according to claim 1 wherein the light source is arranged in the first housing and the light receiver is arranged in the second housing.

11. A light barrier or grid according to claim 1 wherein the light source and the light receiver are each arranged in the first housing, and including a mirror comprising a pair of deflecting mirrors arranged in the second housing.
